(19) United States
(12) Patent Application Publication
(10) Pub. No.: US 2012/0166819 A1
(43) Pub. Date: Jun. 28, 2012

(54) Power Management of Optical Access Networks

(75) Inventors: Bjorn Skubic, Hasselby (SE); David Hood, Palo Alto, CA (US)

(73) Assignee: Telefonaktiebolaget L M Ericsson (publ), Stockholm (SE)

(21) Appl. No.: 12/976,549

(22) Filed: Dec. 22, 2010

(51) Int. Cl. G06F 1/00

(52) U.S. Cl. 713/300

(57) ABSTRACT

Power management is performed in an optical access network to reduce energy consumption. Service information is determined about traffic at the first node. Power management is controlled based on the determined service information. The first node can control power management at the first node and/or the second node. The first node can categorize traffic according to service and determine traffic activity per service. Service information can include service type of the traffic, traffic class of the traffic, and/or quality of service requirements of the traffic.

### TECHNICAL FIELD

This invention relates to optical access networks, such as passive optical networks (PON).

### BACKGROUND

Increasing demand for a range of high-bandwidth communications services is driving a need for high-capacity access networks to provide those services. Optical access networks can deliver the high bandwidths now required. An optical access network typically has apparatus called an Optical Line Terminal (OLT) at a Central Office node. The OLT serves a plurality of optical terminals, called Optical Network Units (ONU). ONUs can be deployed at subscriber premises, at kerbside cabinets, or at other remote locations, depending on the access network architecture. A Passive Optical Network is a type of optical access network with limited, or no, power requirements in the optical path between the Central Office (CO) and ONUs. There are various types of passive optical network which differ in how the resources of the fibre are shared among ONUs. In a Time Division Multiplexing Passive Optical Network (TDM-PON), the resources of the fibre are shared on a time-divided basis among ONUs. Traffic in the downstream direction is broadcast by the OLT to all ONUs, with each ONU extracting traffic destined for itself. Each ONU served by the OLT is allocated time slots in which it can transmit data to the OLT. The time slots can occur at irregular intervals and can have irregular durations. In a Wavelength Division Multiplexed Passive Optical Network (WDM-PON), each ONU is allocated a different wavelength channel, called a lambda, for communication between the OLT and that ONU.

Techniques for reducing the energy consumption of optical access networks have been proposed. In TDM-PONs, energy is consumed by transceivers to keep the link between the ONU and OLT alive, regardless of traffic. It has been proposed to power off the ONU transceiver in a TDM-PON at times of no traffic to save energy.

One proposal is that an optical network unit (ONU) can autonomously enter a low-power state during times of inactivity. This means that an ONU decides for itself, without external control, when to enter a lower power state. Another proposal is that an external entity, such as an OLT, authorises an ONU to enter a lower power state at the discretion of the ONU. When the ONU decides to sleep, it signals to the OLT so the OLT can distinguish between the ONU being asleep and the ONU being at fault. One proposal for ITU-T G.987.3 is for two non-autonomous reduced-power modes referred to as cyclic sleep and doze mode. Cyclic sleep refers to the controlled powering off of the ONU transceiver during short time intervals. Doze mode refers to the controlled powering off of the ONU transmitter, while keeping the ONU receiver powered up and active.

It is desirable to further reduce energy consumption of optical access networks.

### SUMMARY

An aspect of the present invention provides a method of power management in an optical access network. The optical access network comprises at least a first node and a second node. The method determines service information about traffic at the first node. The method controls power management of the optical access network based on the determined service information.

The “first node” can be an entity at the CO side of the access network, such as an Optical Line Terminal (OLT) and the “second node” can be an entity at the subscriber side of the access network, such as an Optical Network Unit (ONU). Alternatively, the “second node” can be an entity at the CO side of the access network, such as an Optical Line Terminal (OLT) and the “first node” can be an entity at the subscriber side of the access network, such as an Optical Network Unit (ONU).

In some embodiments of the invention, it may be possible to reduce energy consumption of the network while still providing an acceptable quality of service, as energy consumption is matched to traffic. For example, during periods of low priority traffic, such as best efforts traffic, it is possible to operate the network in a reduced power state, such as by powering down a transceiver (or part of the transceiver) at a node, or by operating the transceiver (or part of the transceiver) at a node in a cyclic sleep mode with a relatively long off period. During periods of higher priority traffic, it is possible to operate the network in a higher power state, such as by fully powering up a transceiver (or part of the transceiver) at a node, or by operating the transceiver (or part of the transceiver) at a node in a cyclic sleep mode with a relatively short off period. Increasing the length of sleep periods reduces energy consumption.

The term “state” can refer to an operating mode of an OLT or ONU, such as a mode recited in ITU-T G.987.3, or to a specific state of a state machine which describes the behaviour of an OLT or ONU.

The optical access network can be a TDM-PON, WDM-PON, point-to-point optical access network, or any other kind of optical access network.

Another aspect provides a power management control apparatus for an optical access network. The optical access network comprises at least a first node and a second node. The apparatus comprises a monitoring module arranged to determine service information about traffic at the first node. The apparatus comprises a control module arranged to control power management of the optical access network based on the determined service information.

The functionality described here can be implemented in hardware, software executed by a processing apparatus, or by a combination of hardware and software. The processing apparatus can comprise a computer, a processor, a state machine, a logic array or any other suitable processing apparatus. The processing apparatus can be a general-purpose processor which executes software to cause the general-purpose processor to perform the required tasks, or the processing apparatus can be dedicated to perform the required functions. Another aspect of the invention provides machine-readable instructions (software) which, when executed by a processor, perform any of the described methods. The machine-readable instructions may be stored on an electronic memory device, hard disk, optical disk or other machine-readable storage medium or non-transitory medium. The machine-readable instructions can be downloaded to the storage medium via a network connection or pre-installed at a time of manufacture.

### BRIEF DESCRIPTION OF THE DRAWINGS

Embodiments of the invention will be described, by way of example only, with reference to the accompanying drawings in which:

FIG. 1 shows an optical access network according to an embodiment of the invention;

FIG. 2 shows a state diagram of power management states at an ONU of FIG. 1;

FIG. 3 shows a state diagram of power management states at an OLT of FIG. 1;

FIGS. 4 and 5 show apparatus that can be provided at an ONU of the optical access network;

FIG. 6 shows relationship between service/traffic classes and energy saving;

FIG. 7 shows apparatus for monitoring traffic at an OLT or ONU; and

FIG. 8 shows a method performed by a node of the optical access network.

### DETAILED DESCRIPTION

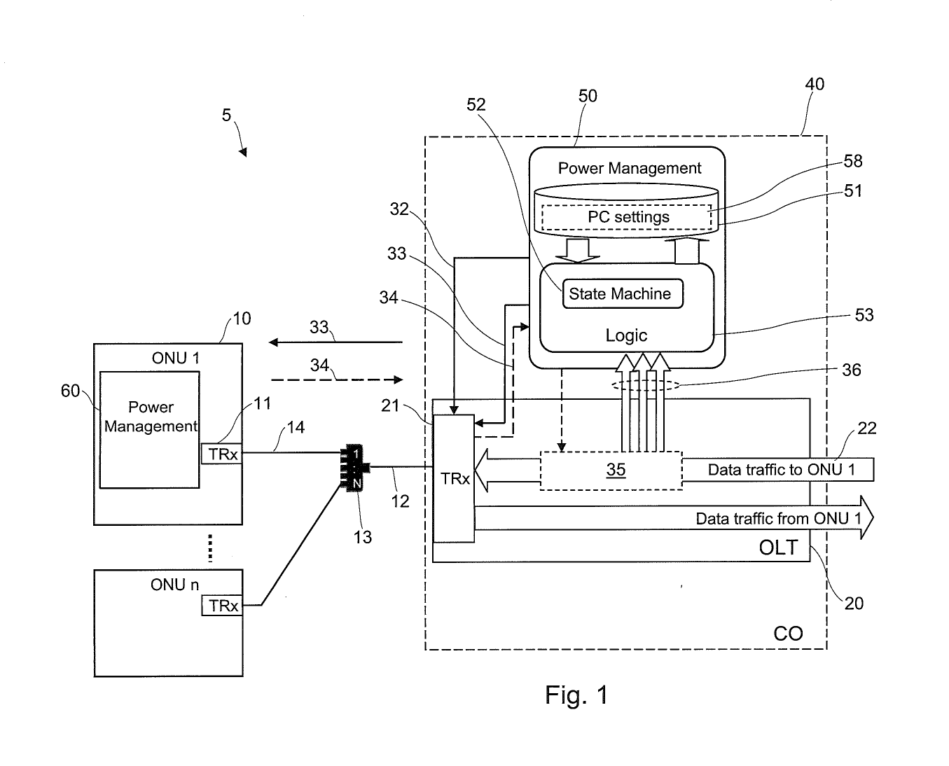

FIG. 1 shows an optical access network 5 according to some embodiments of the present invention. A passive optical network (PON) is shown as an example optical access network architecture. The network comprises an Optical Line Terminal Unit (OLT) 20, typically located at a central office (CO) 40, and a plurality of remote Optical Network Units (ONU) 10. The OLT 20 has a transceiver 21 for optically communicating with a group of ONUs 10. The topology of the access network 5 can comprise a tree and branch topology with a trunk fibre 12, splitter 13 and drop fibres 14 between splitter 13 and ONUs 10. An ONU has a transceiver 11. In the following description, the term “Passive Optical Network” (PON) will be used to describe an OLT 20 connected to a group of ONUs 10. There can be multiple PONs, each PON comprising an OLT 20 at the CO 40 which serves a group of ONUs 10.

In a Time Division Multiplexing Passive Optical Network (TDM-PON), the resources of the fibre 12 are shared on a time-divided basis among ONUs 10. Traffic in the downstream direction is broadcast by the OLT to all ONUs, with each ONU extracting traffic destined for itself. Each ONU served by the OLT is allocated time slots in which it can transmit data to the OLT. The time slots can occur at irregular intervals and can have regular, or irregular, durations. Typically, a scheduling function will allocate time slots to ONUs based on various criteria. In a Wavelength Division Multiplexed Passive Optical Network (WDM-PON), each ONU 10 is allocated a different wavelength channel, called a lambda, for communication between the OLT 20 and that ONU 10.

Power management functionality is provided within the optical access network. A power management control unit 60 is provided at each ONU 10. One or several power management control units 50 are provided for the OLT 20. For the OLT 20 there may be one power management control unit 50 per connected ONU 10. Power management unit 50 can form part of an OLT 20, or a power management unit 50 can be provided as a resource for a group of OLTs 20. In a further alternative, the power management unit 50 can be located in another network entity, such as a network management entity. For autonomous reduced power modes, each power management unit may operate individually. For non-autonomous reduced power modes, power management units may operate in pairs, with one unit on each side of the link which is managed. The power management control units 50, 60 implement power management functions, such as those proposed in ITU-T G.987.3 for XG-PON. Power management functions allow the ONUs 10, or parts of the ONUs (such as the transceivers 11), to reduce their energy consumption at certain times. Power management functions can allow the OLTs 20, or parts of the OLTs (such as the transceivers 21) to reduce their energy consumption at certain times. Power management control units 50, 60 may support power management functions at the same node, at the opposite node (in a pair) or both.

For a power management control unit that supports power management functions on the same node, there is a control channel to each internal node element that is controlled (e.g. transceiver). The state of a controlled node element is determined by the current state of the state machine of the power management control unit.

Regarding the power management control unit, typical forms of control include triggering a change of state in the internal state machine and/or the state machine of the opposite power management unit (in a pair). Furthermore it includes modifying internal power management settings (e.g. timer values) and/or modifying power management setting at the opposite power management unit (in a pair).

There are various scenarios that can be considered:

(i) Power management control unit 50 at an OLT 20 can issue control signals to an ONU 10 based on traffic received at the OLT 20. Control signals influence the power management at the ONU 10 such that it operates in a state matched to the traffic the OLT 20 is about to send to the ONU 10.

(ii) Power management control unit 50 at an OLT 20 can control the operating state of the OLT 20 itself based on traffic received at the OLT 20. The operating state may or may not be associated with power management functions at the OLT 20 itself. FIG. 1 shows a control output 32 to control the transceiver 21 of the OLT 20. The OLT 20 ensures that power management functions, whether on the OLT 20 or ONU 10, are optimised with respect to current traffic demands.

(iii) Power management control unit 60 at an ONU 10 can control the operating state of the ONU 10 itself based on traffic received at the ONU 10. The operating state is most likely associated with power management functions on the ONU 10 itself. The ONU 10 ensures it only consumes as much energy as it needs to for the current traffic demands.

(iv) Power management control unit 60 at an ONU 10 can control the OLT 20 based on traffic received at the ONU 10. The ONU 10 ensures the OLT 20 is operating in a state matched to the traffic the ONU 10 is about to send to the OLT 20.

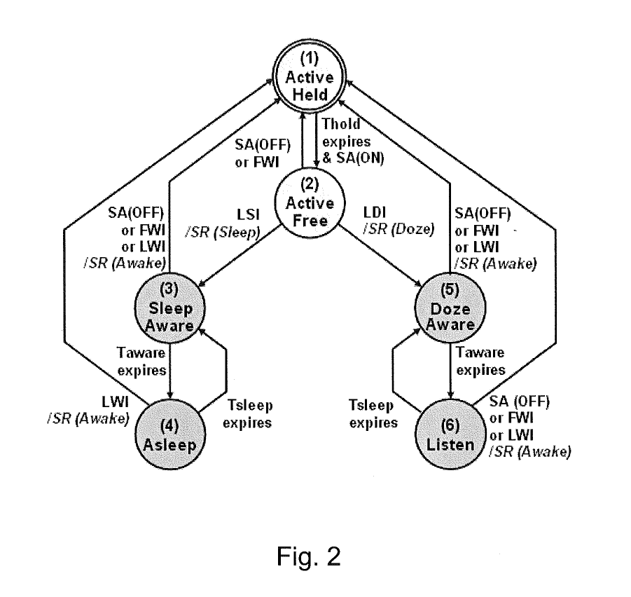

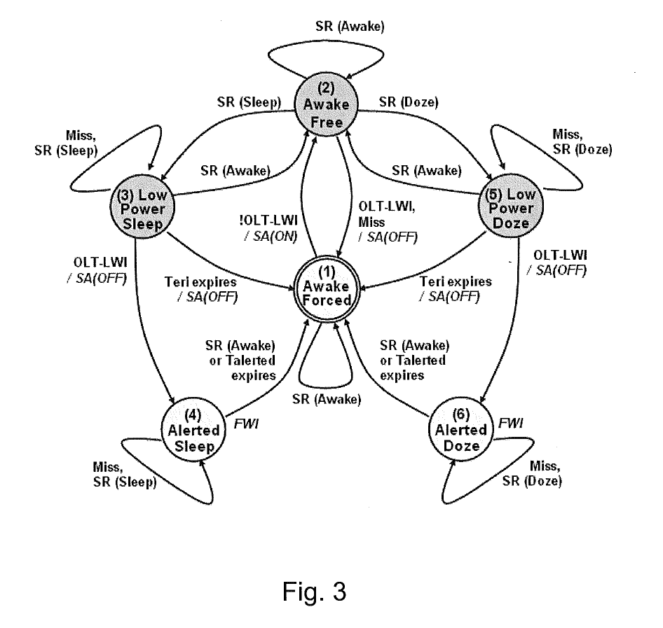

Each ONU 10 operates in one of a set of possible power management modes at any given time. In G.987.3, the possible modes are: Full Power; (Low Power) Doze; (Low Power) Cyclic Sleep. The modes differ in their power requirements. Each power management mode can comprise one or more power management states. A way of controlling power management is to provide a state machine 62 at each ONU 10. An ONU 10 can move between the possible states in response to stimuli, such as signalling received from the power control unit 50 at the OLT 20 or local conditions at the ONU 10, such as expiry of a timer or subscriber traffic activity. Similarly, a state machine 52 or other control logic is provided at the OLT 20 for each of the remote ONUs 10 in the PON. FIG. 2 shows an example power management state diagram for a state machine at an ONU 10 of an XG-PON. The states are described in Table 1. FIG. 3 shows a power management state diagram for the state machine 52 maintained at an OLT 20 for an ONU 10. The states are described in Table 2. The two state diagrams shown in FIGS. 2 and 3 operate in partial state alignment. Each state machine has a set of states, and transitions between states in response to one or more of: signalling 33 sent between the OLT 20 and ONU 10; signalling 34 sent between the ONU 10 and OLT 20; events such as expiration of a timer or traffic activity. Traffic activity can be measured, for example, by packet inter-arrival time or buffer state information. The state machine 52 corresponding to each ONU 10 is updated in response to signalling messages 33, 34 between the ONU 10 and OLT 20. The state machine 31 corresponding to an ONU 10 can also be updated in response to receiving “keep-alive” traffic. The OLT 20 needs to periodically check whether inactivity of an ONU 10 is due to: (i) the ONU 10 being alive (and in a low-power mode) or (ii) the ONU 10 having failed. One way of performing this check is to exchange handshake signalling messages. Another way is by a “keep-alive” traffic exchange. In ITU G.987.3, power management is implemented by signalling messages carried by a physical layer Operations, Administration and Maintenance (PLOAM) messaging channel.

Logic 53 triggers state transitions of the state machine 52 and alters power control settings 51 based on service information or service-specific traffic activity information 36. There are various events that trigger the transitions from one state to another, such as local activity triggers. ITU G.987.3 defines triggers called LDI (local doze indication), LSI (local sleep indication), LWI (local wake-up indication).

Power management control unit 50 comprises a store 51 of power control settings. These are parameters for the logic 53 and operation of the state machine 52. A list of parameters in ITU G.987.3 is provided in Table 3. Values of these parameters can be changed and optimised depending on traffic monitoring.

A monitoring unit 35 monitors traffic 22 arriving at the OLT 20. The monitoring unit monitors traffic activity which can be measured, for example, by packet inter-arrival time or buffer state information. It also determines service information 36 for the monitored traffic or traffic activity of traffic categorized depending on service information. The term “service information” 36 can comprise at least one of the following:

service type of the received traffic;

traffic class of the received traffic; and/or

quality of service requirements of the received traffic.

Traffic activity information and service information 36 is applied to the power management control unit 50. This enables the generation of control signals to the power control state machine 52 which are class/service dependent. The monitored class/service information 36 can also be used for updating power management settings 51, such as timer settings which control transition between states of the state machine 52.

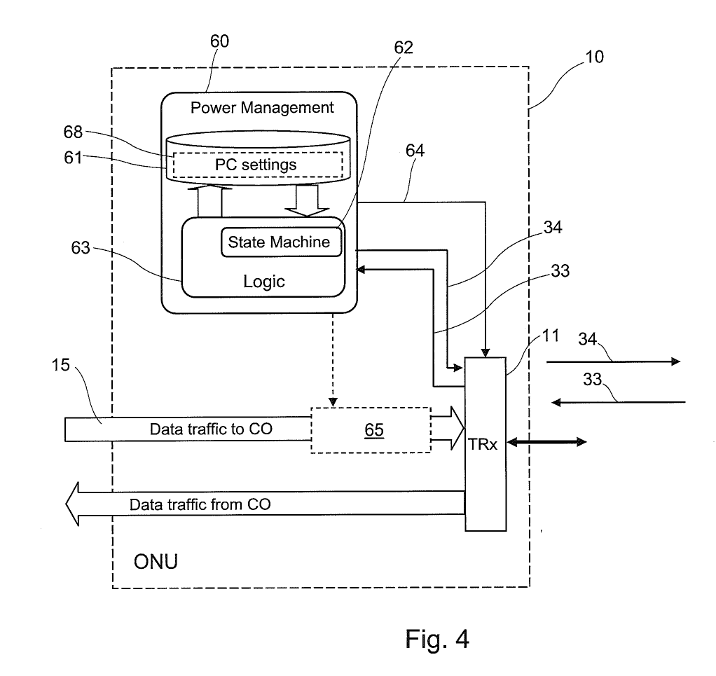

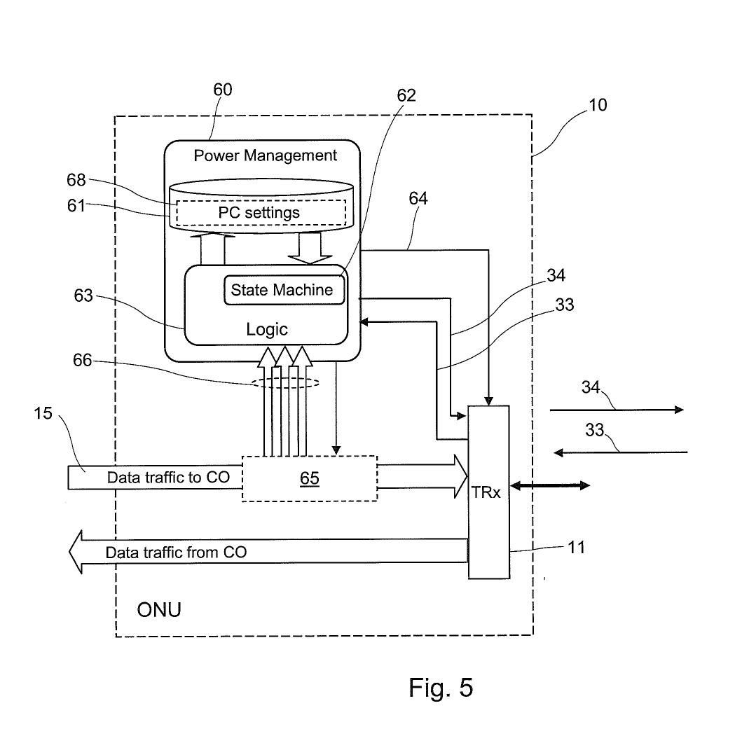

FIGS. 4 and 5 show two possible embodiments of apparatus at an ONU 10. In both of FIGS. 4 and 5, there is a power management control unit 60 which includes control logic 62, 63 to control 64 the transceiver 11. Control 64 can cause the transceiver to sleep or doze. In FIGS. 4 and 5 the power management control unit 60 is responsive to signalling messages 33 received from the power management control unit 50 at the OLT 20. In FIG. 5, ONU 10 also has a monitoring unit 65 for monitoring traffic 15 arriving at the ONU 10 and determining service information 66 for the monitored traffic. Monitoring unit 65 outputs service information 66 to the power management control unit 60. The power management control unit 60 can control the power management of the ONU 10 based on the service information 66 in the same way as described for FIG. 1. For example, the transceiver 11 can operate in a low power state (e.g. sleep mode or with a relatively long sleep interval) if monitoring unit 65 detects low priority traffic, or the transceiver 11 can operate in a higher power state if monitoring unit 65 detects high priority traffic.

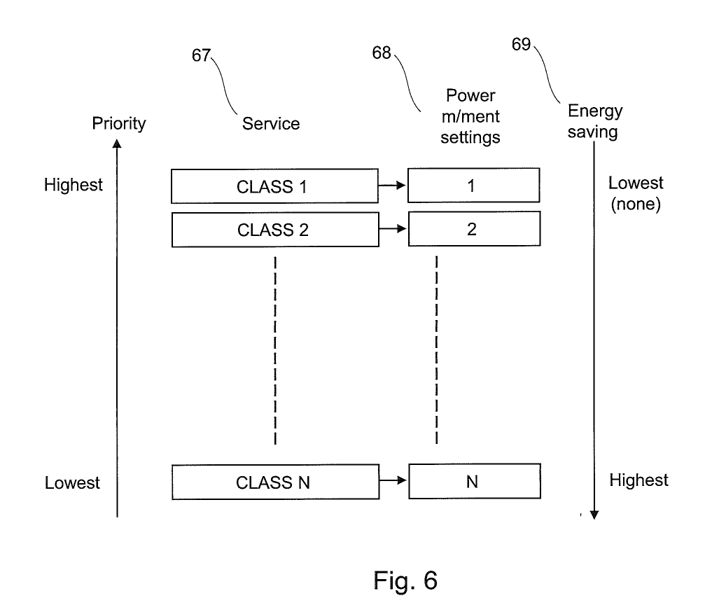

Consider a system where power management (of sleep parameters) is dependent on monitoring of different traffic classes (with different QoS requirements). In BroadBand Forum (BBF) architecture standards there are typically a minimum number of traffic classes that should be supported. These have different priority levels and are scheduled differently in the network. FIG. 6 shows a set of N classes 67 ranked according to priority. The amount of energy saving 69 varies with the priority of class. Consider two different examples. There are power control settings 68 for each possible service class 67. Firstly, consider that the monitoring 35 of traffic received 22 at the OLT 20 indicates that traffic destined for ONU 1 is high priority. High priority could result from the traffic type (e.g. delay sensitive telephony traffic) or traffic which is tagged as having a high QoS requirement. Power management control unit 50, upon receiving the service information 36, adapts the power management behaviour of ONU 1 to ensure that ONU 1 awakes to receive the traffic. Secondly, consider that the monitoring 35 of traffic received 22 at the OLT 20 indicates that traffic destined for ONU 1 is low priority. Low priority traffic could result from the traffic type (e.g. best-effort Internet traffic) or traffic which is tagged as having a low QoS requirement. Power management control unit 50, upon receiving service information 36, adapts the power management behaviour of ONU 1 to ensure that ONU 1 changes to a low power state, or remains in a low power state. Traffic can be buffered at the OLT 20 or, optionally, dropped. An operating parameter that is controlled at a node can include one of: a time period for which a transceiver/transmitter at the node is powered off; a time period for which a transceiver/transmitter at the node is powered on.

Classification of traffic can be performed in various ways. Packets/frames carrying traffic can include a header which carries priority or QoS information. For example, some Ethernet formats add a Tag with Priority bits. The header is inspected and traffic is classified based on the header contents. Other ways of classifying traffic include: classifying by user port; classifying by VLAN Identifier (VID) of an Ethernet frame; deep packet inspection. Advantageously, the classification relates to QoS-requirements, such as traffic with different latency requirements.

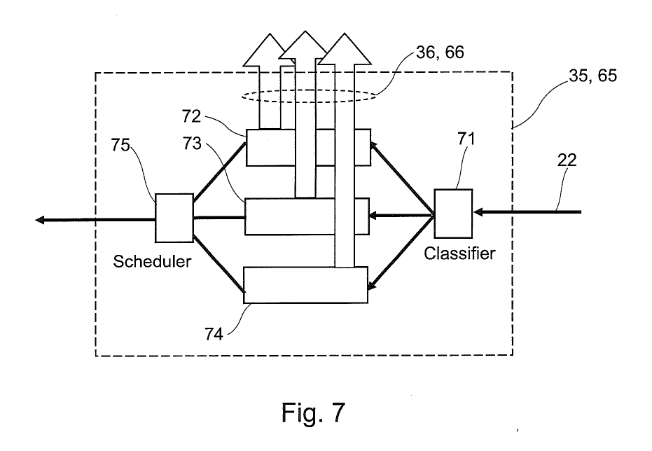

Monitoring 35, 65 can monitor the queue sizes of different logical queues at the OLT 20 or ONU 10. It could also monitor arrival or inter-arrival time of packets for each class/service. FIG. 7 shows an example implementation of the class/service monitoring function 35. A classifier 71 inspects arriving traffic 22 and forwards traffic into buffers 72, 73, 74 for each traffic type/class/service. A scheduler 75 schedules transfer of traffic from buffers 72, 73, 74 to the transceiver 21 for transmission to an ONU or OLT. Monitoring at buffers 72, 73, 74 can include functions such as metering, marking, etc. Service specific buffer state information, service specific arrival or inter-arrival time and service information 36, 66 is output to the power management control unit 50, 60.

The format of the input 36, 66 to the power management control unit could, for example, be a simple indication of active services that the power saving mechanism should take into account. Implementation of the control logic within the power management control unit can be vendor-specific. There is a wide range of algorithm possibilities. If the monitoring information is inter-arrival time between packets, the criteria could be one or several thresholds for the average inter-arrival time (or some other function of the inter-arrival time) at which control signals or setting updates are generated. If the monitoring information is buffer state information, the criteria could consist in one or several thresholds related to buffer size. Power control settings such as timer values for e.g. the sleep period can be determined by a function of the monitored information (e.g. the packet inter-arrival time). As described above, the criteria can be made service specific.

At a particular point in time, traffic between a pair of nodes (OLT, ONU) may comprise multiple different services, such as telephony traffic and best efforts data traffic. Power management control units 50, 60 can adapt power management operation to the most demanding of the currently active services by using power control settings for this service. Hence, service aware power management is used to implement optimal power management settings with respect to type of active traffic, with power control settings defined for each traffic “type”. The traffic types can be ranked with respect to requirements. In some embodiments, the power control settings can be determined based on a combination of service/traffic type and other properties of the monitored information, such as packet inter arrival time.

At times of idleness, system messages between network nodes prevent optimal power management by triggering wake-up. Some of these messages could be considered unnecessary for a node in certain low power states. Messages could include e.g. Address Resolution Protocol (ARP) messages, Internet Group Management Protocol (IGMP) multicast messages, etc. In service aware power management these messages can be buffered so as not to interrupt low power operation. It is also possible to discard messages which are deemed “unimportant” to a node in a low power state. This can be called “service aware dropping”. This avoids extensive buffering at a sending node. This process depends on the destination node, power state information (for the sending node or the destination node) and service information.

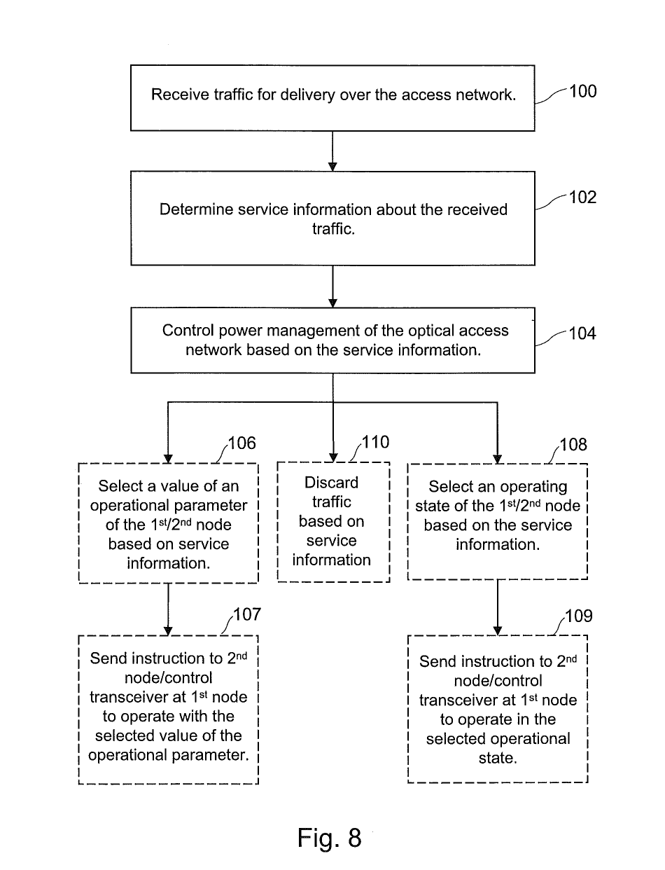

FIG. 8 shows a method performed at a power management control unit at a first node of the access network. The first node can be an OLT 20 or an ONU 10. At step 100, traffic is received for delivery over the access network. For example, this can be traffic received at OLT 20 for delivery to an ONU 10. Alternatively, it can be can be traffic received at ONU 10 for delivery to an OLT 20. Step 102 determines service information about the received traffic. Step 104 controls power management of the optical access network based on the service information. Step 104 can involve one or more of the steps 106, 108, 110. The control of power management can comprise selecting a value of an operational parameter of the first or second node based on the service information (step 106). At step 107, an instruction is sent to the second node or a transceiver at the first node is controlled to operate with the selected value of the operational parameter. The control of power management can comprise selecting an operating state of the first/second node based on the service information (step 108). At step 109, an instruction is sent to the second node or a transceiver at the first node is controlled to operate in the selected operational state. The control of power management can also comprise discarding traffic (step 110).

An XG-PON is an example TDM-PON architecture to which the service-aware power management can be applied. The following power management control messages are used in an XG-PON: OLT-LWI or !OLT-LWI; Local Wake-up Indication (LWI), Local Sleep Indication (LSI); Local Doze Indication (LDI). With the service/traffic type information available by means of the invention, the criteria for issuing, for example, an LWI, LSI or LDI could be made service/traffic type dependent. For high priority services an LWI could be issued at the arrival of a single packet associated with the service. For low priority services the LWI could be issued first when the amount of traffic associated with that service surpasses a certain threshold. Within the XG-PON framework there is limited bandwidth availability also during the cyclic sleep/doze periods that could be used for low bandwidth traffic with low QoS requirements. Also, the duration of sleep/doze periods can be controlled dynamically by means of monitoring service information as well as transition between doze mode and sleep mode.

Modifications and other embodiments of the disclosed invention will come to mind to one skilled in the art having the benefit of the teachings presented in the foregoing descriptions and the associated drawings. Therefore, it is to be understood that the invention is not to be limited to the specific embodiments disclosed and that modifications and other embodiments are intended to be included within the scope of this disclosure. Although specific terms may be employed herein, they are used in a generic and descriptive sense only and not for purposes of limitation.

### Appendix

TABLE 1
The following table gives a summary of the power management states at
an ONU in G.987.3:

| State | Semantics |
|---|---|
| ActiveHeld | The ONU is fully responsive, forwarding downstream |
| | traffic and responding to all bandwidth allocations. Power |
| | management state transitions do not occur. |
| ActiveFree | The ONU is fully responsive, forwarding downstream |
| | traffic and responding to all bandwidth allocations. Power |
| | management state transition requests are a local decision. |
| Asleep | The ONU shuts down both its receiver and transmitter, |
| | retaining the ability to wake up on local stimulus. |
| Listen | The ONU receiver is on; the transmitter is off. The ONU |
| | listens to the downstream signal and forwards downstream |
| | traffic, while retaining the ability to reactivate the |
| | transmitter on local stimulus or receipt of SA (off) from the |
| | OLT. |
| DozeAware | Both ONU receiver and transmitter remain on. This state |
| SleepAware | persists for a specified duration Iaware if not truncated by |
| | the arrival of a local stimulus LWI or receipt of SA (OFF) |
| | from the OLT. The ONU forwards downstream traffic and |
| | responds to all grant allocations. |

The following table gives a summary of the power management states at an ONU in G.987.3:

TABLE 2
The following table gives a summary of the power management states at
an OLT in G.987.3:

| State | Semantics |
|---|---|
| AwakeForced | The OLT provides normal allocations to ONU i, |
| | forwards downstream traffic, and expects a response |
| | to every bandwidth grant. The OLT declares the LOSᵢ |
| | defect on detection of N missed allocations (LOSᵢ |
| | soak count). On transition into this state, the OLT |
| | sends a Sleep_Allow (OFF) PLOAM message, thus |
| | revoking its permission to the ONU to enter a low |
| | power state. |
| AwakeFree | The OLT provides normal allocations to the ONU, |
| | forwards downstream traffic, expects a response to |
| | every bandwidth grant, and is ready to accept a power |
| | management transition indication from the ONU. |
| LowPowerDoze | The OLT supports the ONU in a low power state. The |
| LowPowerSleep | OLT provides normal allocations to the ONU but |
| | expects only intermittent responses from the ONU to |
| | bandwidth grants, as defined by various timers. |
| AlertedDoze | The OLT attempts to wake up the ONU. |
| AlertedSleep | |

The following table gives a summary of the power management states at an OLT in G.987.3:

TABLE 3
Power management of the ONUs is controlled by a set of parameters.
In G.987.3 the parameters include:

| Parameter | Description | Defined by | Known to |
|---|---|---|---|
| Isleep | Isleep is the maximum time the ONU spends | OLT | ONU, |
| | in its Asleep or Listen states, as a count of | | OLT |
| | 125 microsecond frames. Local wakeup | | |
| | indications (LWIs) in both Asleep and Listen | | |
| | states or remote events in Listen state may | | |
| | truncate the ONU's sojourn in these states. | | |
| Tsleep | Local timer at ONU. Upon entry to Asleep | ONU | ONU |
| | state, the ONU initializes Tsleep to a value | | |
| | equal to or less than Isleep. Secondary | | |
| | internal timers may be required to guarantee | | |
| | that the ONU will be fully operational when | | |
| | it enters sleep aware state after an interval not to | | |
| | exceed Isleep. | | |
| Iaware | Iaware is the minimum time the ONU spends | OLT | ONU, |
| | in its Aware state before transitioning to a | | OLT |
| | low power state (Asleep or Listen), as a count | | |
| | of 125 microsecond frames. During the | | |
| | Iaware interval, local or remote events may | | |
| | independently cause the ONU to enter the | | |
| | ActiveHeld state rather than returning to a | | |
| | low power state. | | |
| Taware | Local timer at ONU, initialized to a value | ONU | ONU |
| | equal to or greater than Iaware once | | |
| | downstream synchronization is obtained upon | | |
| | entry to Aware state. Taware controls the | | |
| | dwell time in aware state before the ONU re- | | |
| | enters one of the low power states. | | |
| Itransinit | Complete transceiver initialization time: the | ONU | ONU, |
| | time required for the ONU to gain full | | OLT |
| | functionality when leaving the Asleep state | | |
| | (i.e., turning on both receiver and | | |
| | transmitter). | | |
| Itxinit | Transmitter initialization time: the time | ONU | ONU, |
| | required for the ONU to gain full | | OLT |
| | functionality when leaving the Listen state. | | |
| Talerted | Local timer to bound the time that the OLT | OLT | OLT |
| | state machine remains in an alerted state | | |
| | before entering the AwakeForced state. | | |
| Closᵢ | Counter of missing upstream bursts in OLTs | OLT | OLT |
| | AwakeForced(i) state for loss of signal defect | | |
| | for ONU i. | | |
| Terᵢ | Local handshake timer at the OLT that | OLT | OLT |
| | defines the latest instant at which an upstream | | |
| | burst is expected from sleeping or dozing | | |
| | ONU i. | | |
| Ihold | Minimum sojourn in the ActiveHeld state. | OLT | ONU, |
| | | | OLT |
| Thold | Local timer at the ONU that is initialized to | ONU | ONU |
| | Ihold upon transmission of SR(Awake) after | | |
| | entry into ActiveHeld state and that enforces | | |
| | the minimum sojourn in the ActiveHeld state. | | |

1. A method of power management in an optical access network, the optical access network comprising at least a first node and a second node, the method comprising:
determining service information about traffic at the first node; and
controlling power management of the optical access network based on the determined service information.

2. A method according to claim 1 wherein the step of determining service information comprises classifying traffic according to service and determining traffic activity per service.

3. A method according to claim 1 wherein the step of determining service information comprises determining at least one of:
service type of the traffic;
traffic class of the traffic; and/or
quality of service requirements of the traffic.

4. A method according to claim 1 wherein the second node of the optical access network has at least one operating parameter which, when varied, varies the energy consumption of the second node, and the step of controlling power management of the optical access network comprises:
selecting a value for the operating parameter based on the determined service information; and,
sending the selected value of the operating parameter to the second node.

5. A method according to claim 1 wherein the second node of the optical access network is operable in a plurality of operating states which differ in their energy consumption, and the step of controlling power management of the optical access network comprises:
selecting an operating state for the second node based on the determined service information; and,
sending an instruction to operate in the selected operating state to the second node.

6. A method according to claim 1 wherein the first node of the optical access network has at least one operating parameter which, when varied, varies the energy consumption of the first node, and the step of controlling power management of the optical access network comprises:
selecting a value for the operating parameter at the first node based on the determined service information.

7. A method according to claim 1 wherein the first node of the optical access network is operable in a plurality of operating states which differ in their energy consumption, and the step of controlling power management of the optical access network comprises:
selecting an operating state for the first node based on the determined service information.

8. A method according to claim 4 wherein the operating parameter is one of:
a time period for which a transceiver at the node is powered off;
a time period for which a transceiver at the node is powered on;
a time period for which a transmitter at the node is powered off; and/or
a time period for which a transmitter at the node is powered on.

9. A method according to claim 1 further comprising selectively discarding traffic based on the determined service information.

10. A power management control apparatus for an optical access network, the optical access network comprising at least a first node and a second node, the apparatus comprising:
a monitoring module arranged to determine service information about traffic at the first node;
a control module arranged to control power management of the optical access network based on the determined service information.

11. A power management control apparatus according to claim 10 wherein the monitoring module is arranged to classify traffic according to service and determine traffic activity per service.

12. A power management control apparatus according to claim 10 wherein the monitoring module is arranged to determine at least one of:
service type of the traffic;
traffic class of the traffic; and/or
quality of service requirements of the traffic.

13. A power management control apparatus according to claim 10 wherein the second node of the optical access network has at least one operating parameter which, when varied, varies the energy consumption of the second node, and the control module is arranged to:
select a value for the operating parameter based on the determined service information; and,
send the selected value of the operating parameter to the second node.

14. A power management control apparatus according to claim 10 wherein the second node of the optical access network is operable in a plurality of operating states which differ in their energy consumption, and the control module is arranged to:
select an operating state for the second node based on the determined service information; and,
send an instruction to operate in the selected operating state to the second node.

15. A power management control apparatus according to claim 10 wherein the first node of the optical access network has at least one operating parameter which, when varied, varies the energy consumption of the first node, and the control module is arranged to:
select a value for the operating parameter at the first node based on the determined service information.

16. A power management control apparatus according to claim 10 wherein the first node of the optical access network is operable in a plurality of operating states which differ in their energy consumption, and the control module is arranged to:
select an operating state for the first node based on the determined service information.

17. A method or a power management control apparatus according to claim 10 wherein the first node is one of an optical line terminal unit and an optical network unit and the second node is the other of an optical line terminal unit and an optical network unit.

18. A machine-readable medium carrying machine-readable instructions which, when executed by a processor, cause the processor to perform the method according to claim 1.
